(19) United States
(12) Patent Application Publication
(10) Pub. No.: US 2011/0067377 A1
(43) Pub. Date: Mar. 24, 2011

(54) GAS TURBINE COMBUSTION DYNAMICS CONTROL SYSTEM

(75) Inventors: Kapil Kumar Singh, Rexford, NY (US); Fei Han, Clifton Park, NY (US); Shiva Srinivasan, Greer, SC (US); Kwanwoo Kim, Greer, SC (US); Preetham, Schenecrady, NY (US); Qingguo Zhang, Schenectady, NY (US); Sven Georg Bethke, Dusseldorf (DE)

(73) Assignee: GENERAL ELECTRIC COMPANY, SCHENECTADY, NY (US)

(21) Appl. No.: 12/562,158

(22) Filed: Sep. 18, 2009

(51) Int. Cl. F02C 3/00

(52) U.S. Cl. 60/39.37

(57) ABSTRACT

A system comprises a gas turbine combustor having a plurality of combustor cans, crossfire tubes for connecting combustor cans, and a tubular connection system connecting the combustor cans to control combustion dynamics. The tubular connection system comprises tubes for connecting at least a pair of the combustor cans.

### BACKGROUND

The invention relates generally to methods for controlling the operation of gas turbine engines and, more particularly, to a method of controlling combustion dynamics in gas turbines.

Gas turbine engines include a compressor, a combustor, and a turbine coupled to the compressor. The combustor can include a plurality of combustor cans. Compressed air and fuel are delivered to the combustor cans to produce high-velocity and high-pressure combustion gases. These combustion gases are discharged to the turbine. The turbine extracts energy from the combustion gases for producing power that can be used in several ways such as, for example, to power the compressor, to power an electrical generator, or to power an aircraft.

Gas turbine engines operate under different load conditions that necessitate varying combustion operating conditions for the combustors to meet desired performance. Under some conditions, combustion phenomenon can interact with natural modes of combustors, establishing a feedback cycle. This leads to high-amplitude pressure fluctuations or perturbations. These pressure perturbations are referred to as combustion dynamics. Combustion dynamics are capable of restricting the operating conditions of the gas turbine and can also cause hardware damage or unscheduled shutdown.

Combustion dynamics is an issue faced by all types of combustors. Due to the design, combustion dynamics are relatively more severe for modern pre-mixed combustion systems that were developed in order to achieve reduced emissions. It would therefore be desirable to control combustion dynamics in gas turbine engines.

### BRIEF DESCRIPTION

In accordance with one embodiment disclosed herein, a system comprises a gas turbine combustor having a plurality of combustor cans, crossfire tubes connecting the combustor cans, and a tubular connection system connecting the combustor cans to control combustion dynamics. The tubular connection system comprises tubes for connecting at least a pair of the combustor cans.

In accordance with another embodiment disclosed herein, a system comprises a gas turbine combustor having a plurality of combustor cans, crossfire tubes connecting the combustor cans, and a tubular connection system acoustically connecting the combustor cans to control combustion dynamics. The tubular connection system comprises tubes for connecting head-ends of at least a pair of adjacent combustor cans.

In accordance with another embodiment disclosed herein, a system comprises a gas turbine combustion system having a plurality of combustor cans, crossfire tubes connecting the combustor cans, and a tubular connection system connecting the combustor cans to control combustion dynamics. The tubular connection system comprises tubes for acoustically connecting combustor cans such that an acoustic wave resulting from combustion dynamics of a first combustor can reaches a second combustor can out-of-phase to reduce or cancel combustion dynamics in the second combustor can.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic of a gas turbine engine system.

FIG. 2 illustrates in axial cross section an exemplary combustor can of the combustor.

FIG. 3 illustrates a side view of annular can configuration of an exemplary combustor.

FIG. 4 illustrates a portion of an exemplary combustor.

FIG. 5 illustrates an embodiment of the annular-can system in accordance with aspects disclosed herein.

FIG. 6 illustrates an embodiment of the connection between cans in accordance with aspects disclosed herein

FIG. 7 illustrates another embodiment of the connection between cans in accordance with aspects disclosed herein.

FIG. 8 illustrates another embodiment of the annular-can system in which groups of cans are connected in accordance with aspects disclosed herein.

FIGS. 9-11 illustrate other embodiments of the annular-can system in accordance with aspects disclosed herein.

### DETAILED DESCRIPTION

Embodiments disclosed herein include a system for controlling combustion dynamics in multi-can gas turbine engines. The system includes a dedicated tubular connection system connecting the combustor cans to control combustion dynamics. Although the system and method are described herein in the context of a heavy duty gas turbine engine employed for industrial application, the system and method are applicable to other combustion engine systems utilized in various applications such as, but not limited to, aircraft, marine, helicopter, and prime-mover applications. As used herein, singular forms such as “a,” “an,” and “the” include plural referents unless the context clearly dictates otherwise.

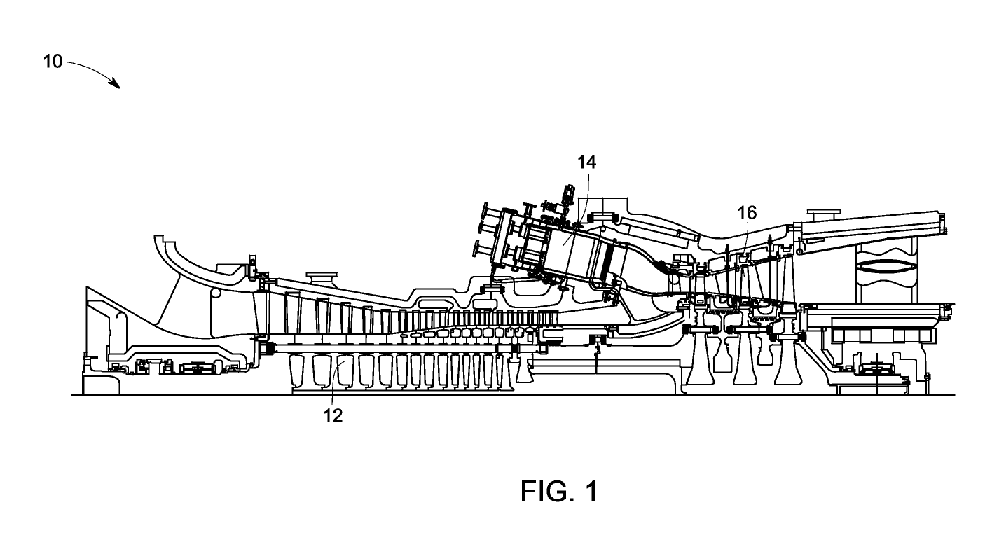

FIG. 1 illustrates an exemplary gas turbine engine 10. The gas turbine engine 10 includes a multi-stage axial compressor 12, a multi-can combustor 14, and a multi-stage turbine 16. The compressor 12 draws air and compresses to higher pressure and temperature. The compressed air is then supplied to the combustor 14. In the combustor 14, the incoming compressed air is mixed with fuel and the fuel-air mixture is combusted to produce high-pressure and high-temperature combustion gases. These combustion gases are discharged to the turbine 16. The turbine 16 extracts energy from the combustion gases. The energy extracted from the turbine 16 can be for various purposes such as generating electrical power, providing propulsive thrust, or providing shaft power for marine or prime mover applications.

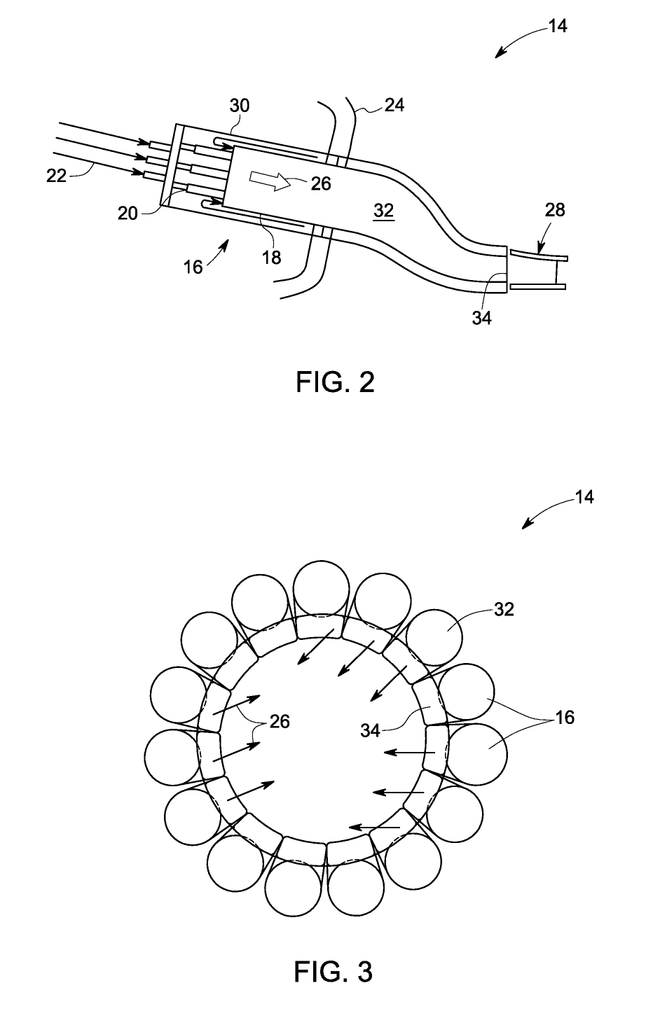

Referring to FIGS. 2 and 3, the combustor 14 includes a plurality of combustor cans 16. Each combustor can 16 includes an annular combustor liner 18 having an upstream dome end at which pre-mixers 20 are located. Each pre-mixer 20 has a corresponding fuel injector for injecting fuel 22, for example, into the pre-mixer for being mixed with a portion of compressed air 24, which mixture is suitably ignited for generating a combustion gas stream 26 inside the combustor liner 18. The combustion gases stream 26 is discharged into an annular high-pressure turbine nozzle 28.

Surrounding the combustor liner is an annular shroud or casing 30 that defines an annular manifold around the liner through which the compressed air 24 is channeled in a conventional manner for both cooling the liner itself, as well as providing air to the pre-mixers.

The combustor 14 is annular and is generally symmetrical about a longitudinal or axial centerline axis of the engine, and includes a row of substantially identical combustor cans 16 as illustrated in FIG. 3. Since each combustor liner 20 is generally cylindrical or circular in radial section, each combustor can 18 further includes an integral transition piece 32 that terminates in a corresponding outlet 34. The transition piece outlets 34 from the corresponding combustor cans adjoin each other around the perimeter of the combustor to define a segmented annulus for collectively discharging the separate combustion gas streams 26 into the common first stage turbine nozzle 28.

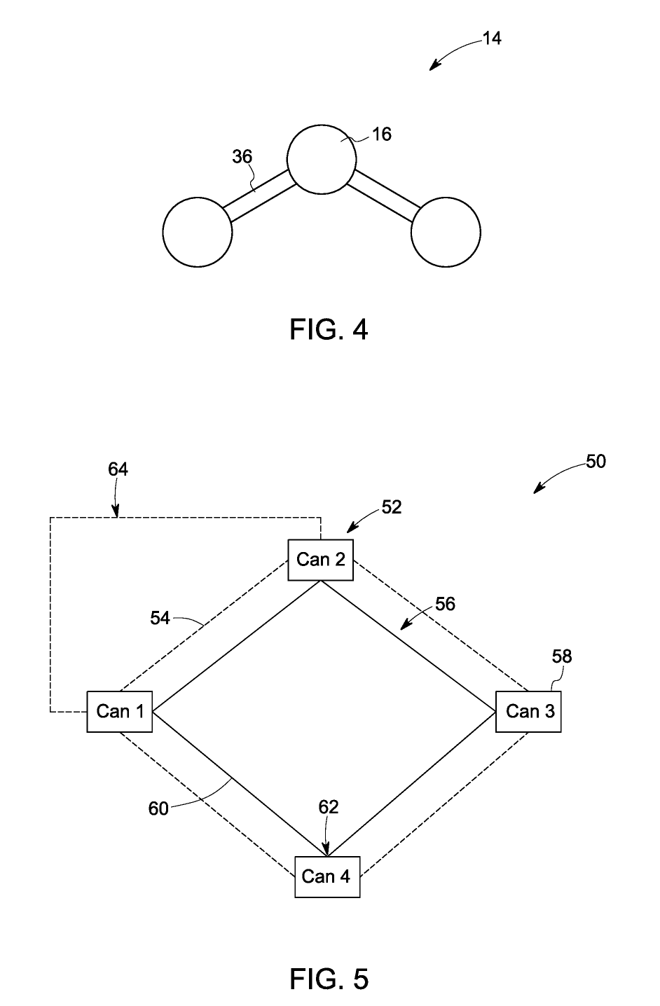

FIG. 4 illustrates a portion of combustor 14 with three combustor cans 16. Crossfire tubes 36 connect adjacent combustor cans 16. The crossfire tubes 36 provide for the ignition of fuel in one combustion can from ignited fuel in an adjacent combustion can, thereby eliminating the need for a separate igniter in each combustor can. Specifically, when can to can crossfire is desired, it is accomplished by a pressure pulse of hot gases transferring from a firing can to an unfired can through the crossfire tube. The crossfire tubes 36 may also serve the purpose of equalizing to some extent the pressures between combustor cans 16.

Combustion dynamics in can-annular combustion systems show acoustic pressure distributions that can be categorized into two modes. One mode is characterized by in-phase oscillations of adjacent combustor cans. In another mode, adjacent combustor cans fluctuate out-of-phase, i.e. the mode-shapes in two adjacent cans are out-of-phase. Due to the structure of the mode shape across the flow-path through the can, the pressure inside the head-end volume of a can also fluctuates out-of-phase compared to neighboring cans. Multi-can combustors also have a tendency to crosstalk between combustor cans via flow paths connecting those cans.

FIG. 5 illustrates an embodiment of the system 50 of the present invention. The system 50 includes a gas turbine combustor 52, crossfire tubes 54, and a tubular connection system 56. The combustor 52 includes multiple combustor cans 58. As an example, four combustor cans 58 and a single crosstalk flow path 64 are shown in the figure. The crossfire tubes 54 connect the adjacent combustor cans 58. The tubular connection system 56 includes tubes 60 for connecting combustor cans.

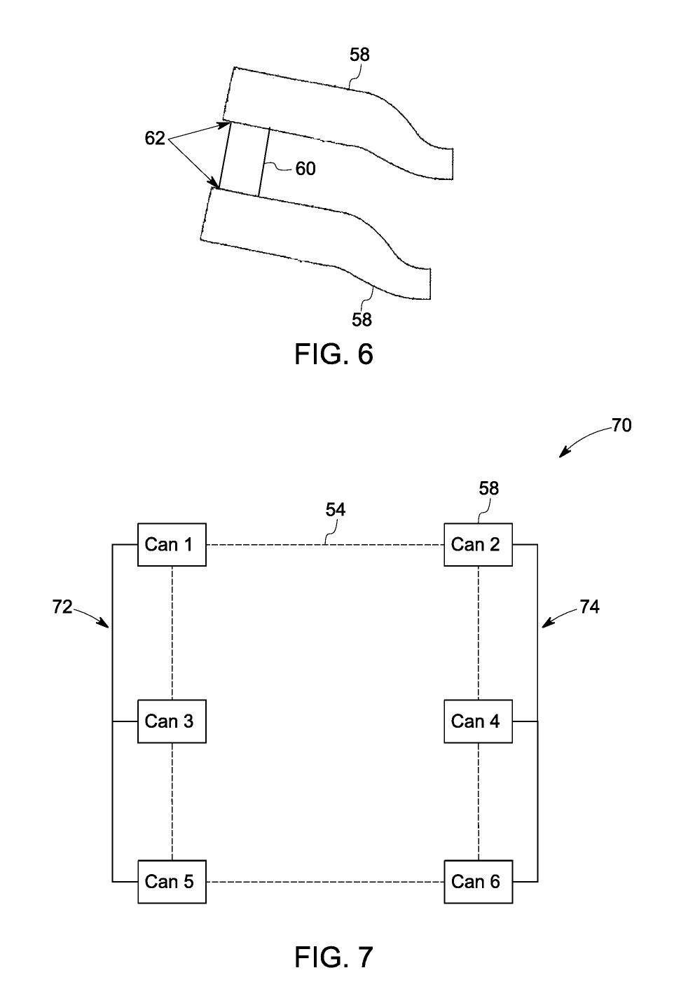

The tubular connection system 56 controls and eliminates combustion dynamics modes. In the embodiment shown in FIGS. 5 and 6, the tubes 60 acoustically connect the head-ends 62 of adjacent combustor cans 58. The tubes 60 are designed such that the flow area of the tubes 60 is larger than the flow area of the crossfire tubes 54. In one embodiment, the flow area of the tubes 62 is at least as large as the diameter of the head-end 62 and larger than can-to-can crosstalk flow area. In one embodiment, the diameter of the tubes is about 0.7 to about 1.0 times the diameter of the head-end.

The tubes 60 act as acoustic pathways. The larger flow area of the tubes 60 compared to can-to-can crosstalk 64 areas and the crossfire tubes 54 between the combustor cans 58 forces an additional pressure-node between the combustor cans 58. Because of the smooth pressure distribution that is enabled by the large flow area of tubes 60, the pressure amplitude inside the head-end 62 volume will be efficiently decreased.

If the diameter of the tubes 62 is appropriately large, there is no additional impedance step inserted and the smooth pressure distribution will force lower pressure amplitude inside the head-end volume and hence deforms the total mode-shape and shifts the frequencies of combustion dynamics. This will detune flame-heat-release excitation and combustion system acoustics and lowers the pressure amplitudes at the flame location and at the location of fuel injection and, therefore, damps the interaction between source, i.e. heat-release fluctuations of the flame, and acoustics.

Depending on circumferential mode-shapes that may be developed around the annulus, head ends of combustor cans 58 are connected in groups to disconnect the full annulus and cut the annulus into two or more parts. For example, in one embodiment 70 as shown in FIG. 7, the annulus of combustor cans is divided into two parts. The tubular connection system is divided into two groups of tubes. The first group of tubes 72 connect head ends of a first set of cans, namely, cans ‘1’, ‘3’, and ‘5.’ The second group of tubes 74 connect head ends of a second set of cans, namely, cans ‘2’, ‘4’, and ‘6.’

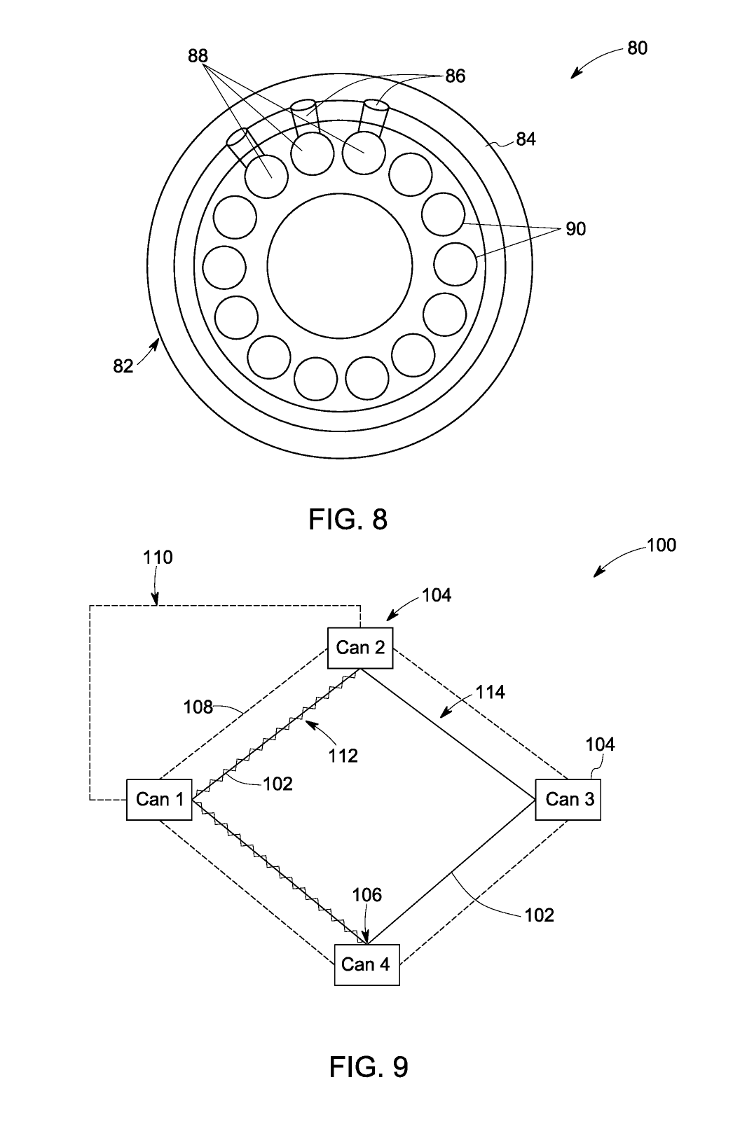

In another embodiment 80 as shown in FIG. 8, the tubular connection system 82 includes a primary tube 84 and secondary tubes 86. In one embodiment, the primary tube is a circular tube provided around the annulus of head ends 88 of combustor cans 90. The secondary tubes 86 act as connections between the head ends 88 and the primary tube 84. Each secondary tube 86 connects a head end of a combustor can to the primary tube 84. Alternately, the secondary tubes 86 can be used to connect head ends of only a group of combustor cans 90 to the primary tube 84.

FIG. 9 illustrates another embodiment of the annular-can system 100. The tubes 102 connect the adjacent combustor cans 104. In one embodiment, the tubes are connected to the combustion section 106 of the cans 104 where the flame is present and maximum heat release is expected. In one embodiment, the diameter of the tubes 102 is about 4 to 6 times the diameter of crossfire connections 108. However, larger or smaller diameters are acceptable as per the hardware requirement and selected cans and their relative location.

As described previously, the combustor cans 104 are already connected through crossfire tubes 108 and crosstalk 110. Although a particular can is operating normally, combustion dynamics of other cans can drive normally operating combustor can through crosstalk or crossfire tubes. The criterion for various configurations of the tubular connection system is that an acoustic wave 112 resulting from combustion dynamics of a particular combustor can, reaches a connected combustor can out-of-phase with combustion dynamics in the connected combustor can, to reduce or cancel combustion dynamics in the connected combustor can.

For example, if combustion dynamics in first combustor can (Can ‘1’) is ‘+x’ units and combustion dynamics of the second combustor can (Can ‘2’) is out-of-phase at ‘−x’ units, then the acoustic wave 112 resulting from combustion dynamics of the first combustor can reaches the second combustor can and cancels the combustion dynamics of the second combustor can or vice versa. The higher the amplitude of combustion dynamics in one can, the stronger the cancellation force in the connected cans. For example, if the amplitude of combustion dynamics in first combustor can is ‘+2x’ units and the amplitudes of combustion dynamics of the second and fourth (Can ‘4’) combustor cans are each at ‘−x’ units, then the acoustic wave resulting from the first combustor can reaches the second and fourth combustor cans and cancels the combustion dynamics of the second and fourth combustor cans. The tubular connection system 114 therefore enables self-cancellation of combustion dynamics across connected cans 104.

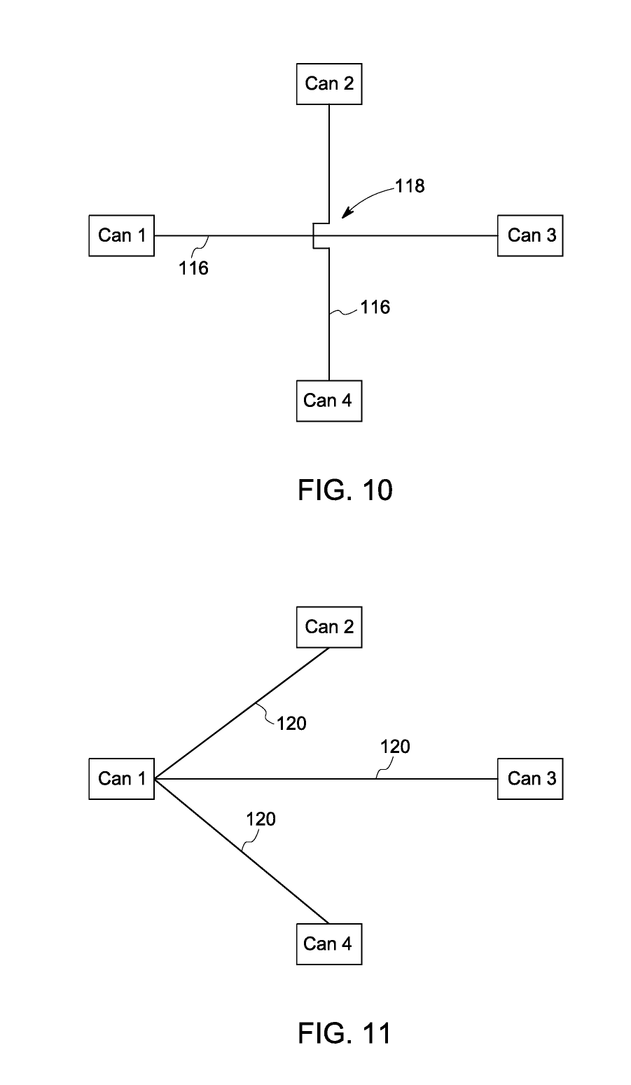

In another embodiment as shown in FIG. 10, the tubes 116 of the tubular connection system 118 connect every alternate combustor cans. In another embodiment, a single can is connected to multiple combustor cans. For example, as shown in FIG. 11, tubes 120 connect the first combustor can to second, third, and fourth combustor cans. An acoustic wave resulting from combustion dynamics of the first combustor can reaches the second, third (Can ‘3’), and fourth combustor cans out-of-phase to reduce or cancel combustion dynamics in the second, third, and fourth combustor cans.

By tuning the length and choice of the cans the connections can be optimized for various modes/tones. For both in-phase and out-of-phase modes neighboring can connections as well as connections to non-adjacent cans may be considered. The length and size of tubes depend on the targeted frequency and its associated mode-shape. Further, the choice of connecting cans depends on the resulting tube geometry and available space between various cans. This may also necessitates direct connections to cans further away from the original can. In addition, the choice of connecting cans also depends on number of cans in the system that controls their separation.

The systems described above thus provide a way to control combustion dynamics in multi-can combustor systems by enabling acoustic interaction between the combustor cans. The system by itself limits, cancels, or controls combustion dynamics. The system can be used with existing gas turbine without any major modifications. The tubular connection system can be retrofitted to existing gas turbines. The design of the crossfire tubes connecting the combustion cans need not be changed.

It is to be understood that not necessarily all such objectives or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objectives or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system comprising:
a gas turbine combustor having a plurality of combustor cans;
crossfire tubes connecting the combustor cans; and
a tubular connection system connecting the combustor cans to control combustion dynamics, the tubular connection system comprises tubes for connecting at least a pair of the combustor cans.

2. The system of claim 1, wherein the tubes connect adjacent combustor cans.

3. The system of claim 1, wherein the tubes comprise at least two groups of tubes, with each group of the tubes connecting only a set of the combustor cans.

4. The system of claim 1, wherein the tubes connect head ends of the combustor cans.

5. The system of claim 4, wherein the diameter of the tubes is about 0.7 to about 1.0 times the diameter of the head-end.

6. The system of claim 1, wherein the tubes are so dimensioned that the flow area of the tubes is larger than the flow area of the crossfire tubes.

7. The system of claim 1, wherein the tubes are so dimensioned that the flow area of the tubes is larger than can-to-can crosstalk area.

8. The system of claim 1, wherein the tubes connect a combustor can among the combustor cans to a plurality of other combustor cans among the combustor cans.

9. The system of claim 1, wherein the tubes connect alternate combustor cans.

10. The system of claim 1, wherein the tubes connect the combustor cans such that an acoustic wave resulting from combustion dynamics of a combustor can among the combustor cans reaches a connected combustor can out-of-phase with combustion dynamics in the connected combustor can to reduce or cancel combustion dynamics in the connected combustor can.

11. The system of claim 1, wherein the tubes connect a first combustor can to a plurality of other combustor cans such that an acoustic wave resulting from combustion dynamics of the first combustor can reaches the plurality of other combustor cans out-of-phase to reduce or cancel combustion dynamics in the plurality of other combustor cans.

12. The system of claim 1, wherein the tubes connect combustion sections of the combustor cans.

13. The system of claim 1, wherein the tubes comprise a primary tube and at least one secondary tube, the secondary tube connects a combustor can among the combustor cans to the primary tube.

14. The system of claim 13, wherein the at least one secondary tube connects a head end of the combustor can to the primary tube.

15. A system comprising:
a gas turbine combustor having a plurality of combustor cans;
crossfire tubes connecting the combustor cans; and
a tubular connection system acoustically connecting the combustor cans to control combustion dynamics, the tubular connection system comprises tubes for connecting head-ends of at least a pair of adjacent combustor cans.

16. The system of claim 15, wherein the tubes comprise at least two groups of tubes, with each group of the tubes connecting only a set of the combustor cans.

17. The system of claim 15, wherein the tubes connect head-ends of all the adjacent combustor cans in each set of the combustor cans.

18. The system of claim 15, wherein the diameter of the tubes is about 0.7 to about 1.0 times the diameter of the head-end.

19. The system of claim 15, wherein the tubes are so dimensioned that the flow area of the tubes is larger than the flow area of the crossfire tubes.

20. The system of claim 15, wherein the tubes are so dimensioned that the flow area of the tubes is larger than can-to-can crosstalk area.

21. The system of claim 15, wherein the tubes comprise a primary tube and at least one secondary tube, the secondary tube connects a head end of a combustor can among the combustor cans to the primary tube.

22. A system comprising:
a gas turbine combustion system having a plurality of combustor cans;
crossfire tubes connecting the combustor cans; and
a tubular connection system connecting the combustor cans to control combustion dynamics, the tubular connection system comprises tubes for acoustically connecting combustor cans such that an acoustic wave resulting from combustion dynamics of a first combustor can reaches at least a second combustor can out-of-phase to reduce or cancel combustion dynamics in the second combustor can.

23. The system of claim 22, wherein the tubes connect adjacent combustor cans.

24. The system of claim 22, wherein the tubes connect a combustor can among the combustor cans to a plurality of other combustor cans among the combustor cans.

25. The system of claim 22, wherein the tubes connect alternate combustor cans.

26. The system of claim 22, wherein the tubes acoustically connect the first combustor can to a plurality of other combustor cans such that an acoustic wave resulting from combustion dynamics of the first combustor can reaches the plurality of other combustor cans out-of-phase to reduce or cancel combustion dynamics in the plurality of other combustor cans.

27. The system of claim 22, wherein the tubes connect combustion sections of the combustor cans.

28. The system of claim 22, wherein the diameter of the tubes is about 4 to 6 times the diameter of the crossfire tubes.
